(19) United States
(12) Patent Application Publication
(10) Pub. No.: US 2014/0044856 A1
(43) Pub. Date: Feb. 13, 2014

(54) PASTE FOOD FOR SWINE

(71) Applicant: Carlos CHAVEZ DELGADILLO, Santiago Atlatongo (MX)

(72) Inventor: Elias Chavez Delgadillo, Santiago Atlatongo (MX)

(73) Assignee: Carlos CHAVEZ DELGADILLO, Santiago Atlatongo (MX)

(21) Appl. No.: 14/111,969

(22) PCT Filed: Jun. 8, 2011
(86) PCT No.: PCT/MX11/00071

§ 371 Date: Oct. 15, 2013

(30) Foreign Application Priority Data
Apr. 14, 2011 (MX) MX/A/2011/003976

(51) Int. Cl. A23K 1/18

(52) U.S. Cl. CPC A23K 1/184
USPC 426/623

(57) ABSTRACT

The present invention relates to a foodstuff for pigs that has a high percentage of moisture and a pasty consistency. The paste foodstuff is prepared from meal made from grains cooked in alkali and ingredients that are commonplace in animal nutrition, with subsequent mixing with water in order to form a paste prior to serving in a free-access . The advantages thereof include a reduction in the amount of foodstuff consumed by the animal and a reduction in the amount of foodstuff wasted, thereby enhancing the foodstuff conversion efficiency and thus reducing overall nutrition costs in a pig-rearing facility. The invention includes the paste foodstuff and the method for the production thereof.

### TECHNICAL FIELD

The present invention relates to a feed for swine with high humidity percentage and pasty consistency. The food is made from flours of grains cooked in alkali (alkaline solution) and ingredients common in animal feed and then mixed with water to achieve between 65% and 75% of moisture to form a pasty consistency, which is served in with free access. The invention aims to reduce the amount of dry matter consumed by intensive fattening swine and in this way increase the efficiency of the food use. A secondary aim is to reduce the amount of dry material wasted by the animal, compared to other forms of food (food in flour and tablet form), allowing to reduce the total quantity of feed offered to the animal, reducing feed costs in a swine production. The pasty texture of the food and the use of flours from grains cooked in alkali are two innovations in food production for animal consumption that make to the paste food, one alternative completely different to current forms of feeding for swine.

### PRIOR ART

Generally, the types of food for swine today existing may be divided into two major groups, dry food and wet food. Dry foods are flours, tablets (pellets) and extruded foods (croquettes), the wet foods, mainly liquid diets consist in mixing a conventional flour food or a byproduct from the food industry for human consumption, with water to obtain a soup, which is drunk by the animal; said soup can be fermented or not by microorganisms to improve the microbial flora of the digestive tract of the swine.

The compressed foods (pellets) improve the daily weight gain and feed conversion, in relation to flour foods, this is achieved by allowing that foods with small particle size are compressed, and therefore the animal consumes more food per mouthful, in addition by receiving a thermal treatment, using steam or hot water during the conditioning prior to pelletizing, the starch is partially gelatinized, which could also improve the feed digestibility. Thus, also the liquid diets improve the feed conversion and daily weight gain in relation to flour foods, but without the starch being gelatinized, this is caused because the water increases the contact surface and facilitates the digestion reactions; should be noted that there is not significant difference in dry matter intake between compressed diets (pellet) and liquid diets, and that the amount of food wasted between dry and liquid foods is similar, so that the swine producers choose the cheapest option for them.

In a swine fattening, the feed cost represents approximately 70% of total production costs, said cost is related to the food price, feed intake by the animal and the amount of food that is wasted, that is, food that is not consume by the animal but the animal throws and dirty, making impossible re-placed it in the , so that the fattening person (swine producer) seeks obtain the best results in the fattening at minimum cost.

The paste food is a technological innovation that allows reducing the amount of consumed and wasted food in swine fattening, this is achieved thanks to its pasty texture, which increases about three times the dry feed volume, but without become it liquid, so that the animal has the feeling of eating and not that it is drinking, so that it satisfies its hungry faster than with compressed foods or liquid foods, furthermore, the pasty texture hinders that the animal throws the food from the , thus reducing the feed amount wasted by the animal; allowing said advantages the reduction of the total dry food provided to the animal, thereby reducing feed costs in swine farms.

### DISCLOSURE OF THE INVENTION

The present invention is a food for swine in intensive fattening, made from flour of grains cooked in alkali, and traditional ingredients in animal feed (high protein sources like pasta from oleaginous plants, high fiber sources such as cereal husks, mineral salts, vitamins and amino acids), the ingredients are dry mixed and water is added to achieve 72% of moisture, stirring until obtain a pasty consistency, finally the pasta is conveyed to the s where is provided for free access.

The present invention also proposes a method for balancing of the dry feed, which consists in using certain proportions of ingredients, proposed in Table 1.

TABLE 1
Proportions of ingredients in the paste food

| Ingredient | % DM |
|---|---|
| Grain Flour | 50-65 |
| Fiber Source | 2-6 |
| Protein Source | 20-38 |
| Vit. AA. Min** | 0-2 |
| Concentrated sources of energy | 0-10 |

* Dry matter percentage
**Vitamins, Amino Acids and Minerals

Mix the dry feed with water to achieve a moisture percentage between 65% and 75% to form a pasty consistency feed.

The grains cooked in Alkali are grains with high starch content, such as yellow corn, white corn or sorghum, with less than 20 ppb of Aflatoxin B1, which were cleaned to remove broken, damaged grains, and foreign material, cooked in an alkaline solution, to modify the starch present in the grains and then allow the formation of the paste, being able to vary the cooking process according to available technology, the grains are milled to reduce the particle size, and dried to reduce the amount of water present in the flour, the flour should have a moisture content below 11% and at least 75% of the flour shall pass through the sieve of 0.250 mm mesh opening.

Fiber sources are generally husks or bran from grains with a crude fiber percentage above 15%.

A protein sources refers to the use of pastes of oleaginous plants, animal origin flour, insect flour or microbial biomass with crude protein content above 20%.

The concentrated sources of energy are generally vegetable oils or animal fats, which provide large amount of energy in the diet.

Sources of vitamins, amino acids and minerals are optional, depending on the nutritional profile of the other ingredients used.

The dry ingredients should be mixed using mixer, preferably a helical ribbon mixer, first adding the flour of grains cooked in alkali, then protein sources, followed by the fiber sources, then the vitamin, amino acid and mineral premixes, finally the concentrated sources of energy; the variation coefficient in the mixture should be below 10%; depending on the type of mixer, the mixing time may vary between 2 to 15 minutes. The dry food should be stored in a free moisture and clean place, being able to be in bulk, in hopper or super sacks, or else in bundles on pallet, in order to keep the food in stable conditions until use.

To supply food to the animals is necessary to form the paste, for this, water is added to a stirred tank and is caused a turbulent flow, then dry food is added to the tank to form a colloidal complex of pasty consistency, between 65% and 75% moisture, which is transported to the s and served with free access; as a result it will be obtained a reduction in food consumption and waste of dry feed between 20 and 35% compared with the flour or tablet foods.

### PREFERRED EMBODIMENT OF THE INVENTION

The following examples of feed formulation are designed for intensive fattening pigs weighing more than 50 kg, the examples are not intended to limit in any way the scope of the invention, are illustrative only.

### EXAMPLE 1

| Ingredient | % DM |
|---|---|
| Canola paste (39% PC) | 14% |
| White cornmeal (alkali) | 60% |
| Minerals and vitamins | 2% |
| Wheat bran | 4% |
| Soybean paste (46% PC) | 14% |
| Vegetable oil | 6% |

The dry feed is mixed with water in a ratio of 1 kg of dry feed with 2.3 kg of water, forming a paste with 72.5% moisture.

### EXAMPLE 2

| Ingredient | % DM |
|---|---|
| Canola paste (39% PC) | 10% |
| Yellow Cornmeal (alkali) | 58% |
| Nonfat dry milk | 20% |
| Minerals and vitamins | 2% |
| Wheat bran | 2% |
| Fat | 8% |

The dry feed is mixed with water in a ratio of 1 kg dry feed with 2.3 kg of water, forming a paste with 72.18% moisture.

### EXAMPLE 3

| Ingredient | % DM |
|---|---|
| Canola paste (39% PC) | 20% |
| Sorghum flour (alkali) | 60% |
| Minerals and vitamins | 2% |
| Wheat bran | 4% |
| Soybean paste (46% PC) | 8% |
| Fat | 6% |

The dry feed is mixed with water in a ratio of 1 kg of dry feed with 2.1 kg of water, forming a paste with 71.3% moisture.

Having described the invention I consider as a novelty and therefore claim legal protection by the patent, what is contained in the following claims:

1. Paste food for intensive fattening pigs, which reduces the amount of dry matter consumed and wasted by the animal, characterized by comprising:
A. 50% to 65% dry matter of grain flour, with high starch content, cooked in alkali
B. 2% to 6% dry matter from fiber sources that may be husk or bran from grains with a crude fiber percentage above 15%.
C. 20% to 38% dry matter from protein sources that may be pastes from oleaginous plants, animal origin flour, insect flour or microbial biomass with a crude protein percentage above 20%.
D. 0% to 10% dry matter from concentrated energy sources that may be vegetable oils or animal origin fats.
E. 0% to 2% dry matter from vitamin, amino acid, and mineral sources, depending on the nutritional profile of the other ingredients used.
F. 65% to 75% moisture content.

2. The food according to claim 1, characterized by comprising grains with high starch content, cleaned, cooked in alkaline solution, ground and dried to have flour form, with a moisture content below 11% and at least 75% of the flour shall pass through the sieve of 0.250 mm mesh aperture.

3. The food according to claim 1, characterized by being a colloidal complex, paste shaped containing a moisture percentage between 65% and 75%.

4. A process to obtain the paste food for pigs according to claim 1 characterized by comprising the following steps:
A. Obtaining grain flour with high starch cooked in alkali, with moisture content bellow 11% and at least 75% of the flour shall pass through the sieve of 0.250 mm mesh aperture, being able to vary the cooking process.
B. Weigh of dry ingredients
C. Mix using mixer to obtain a mixing efficiency with a variation coefficient less than 10%
D. Optional storage of the dry food until use.
E. Mix with water to obtain a moisture content between 65% to 75%.
